(19) United States
(12) Patent Application Publication
(10) Pub. No.: US 2013/0078383 A1
(43) Pub. Date: Mar. 28, 2013

(54) USE OF THE SAME TINT COMPOSITION FOR MULTILAYER COATINGS

(71) Applicant: E I DU PONT DE NEMOURS AND COMPANY, Wilmington, DE (US)

(72) Inventors: AYUMU YOKOYAMA, WALLINGFORD, PA (US); RAJESH GOPALAN SALIYA, PHILADELPHIA, PA (US)

(73) Assignee: E I DU PONT DE NEMOURS AND COMPANY, Wilmington, DE (US)

(21) Appl. No.: 13/626,290

(22) Filed: Sep. 25, 2012

Related U.S. Application Data
(60) Provisional application No. 61/539,059, filed on Sep. 26, 2011.

(51) Int. Cl. C09D 133/00; C08K 5/357; C08K 5/23; C08K 5/3447; C08K 5/3437; B05D 1/38; C08K 5/08; C08K 5/05; C08K 5/07; C08K 5/06; B05D 1/36; C08K 5/3417; C08K 5/45

(52) U.S. Cl. 427/379; 524/89; 524/97; 524/190; 524/92; 524/94; 524/88; 524/90; 524/84; 524/358; 524/379; 524/356; 524/366; 524/377; 427/407.1

(57) ABSTRACT

The present disclosure relates to a refinish coating system comprising two or more coating compositions wherein each coating composition uses the same tint composition. The coating system can provide a coating that more closely matches a color standard than does a system utilizing two differently tinted coating compositions.

### FIELD OF THE DISCLOSURE

The present disclosure is directed to a coating system comprising at least one tint composition that can be used in multiple layers of a refinish coating system. Each layer of the coating system uses the same tint composition for each coating composition.

### BACKGROUND OF DISCLOSURE

Original Equipment Manufacturers (OEM) automotive coating systems generally involve a multilayer coating process. The substrate is usually a metallic surface, although some polymeric substrates can be present. Metal substrates, optionally treated with one or more anticorrosive washes, such as, for example, zinc phosphate or iron phosphate, are typically coated with an electrodeposited layer which serves to protect the metal from corrosion. The electrocoated layer is generally heated to cure the applied layer before the application of a primer layer which serves to protect the electrodeposited layer from photo-oxidation due to the transmission of visible or ultraviolet radiation through the multilayer coating composite. The primer layer also provides a smooth and chip resistant coating for the subsequently applied layers. The primer composition is also heated to cure the coating prior to the application of the next layer or layers. Once the primer composition has been dried and cured, one or more layers of a basecoat composition can be applied to provide the color area for the substrate. The basecoat layers are typically flash dried to remove at least a portion of the solvent, but are generally not cured prior to the application of a clearcoat composition. The clearcoat composition provides a durable exterior coating that protects the underlying layers. After application of the clearcoat composition, the applied layers of basecoat and clearcoat compositions are heated to dry and cure the composite multilayer composition.

If a portion of the OEM coating has been damaged, it can be repaired with the use of a refinish coating system. The refinish coating systems that are supplied by paint manufacturers generally provide the necessary materials to repair each of the originally applied coating compositions with the exception of the electrocoating composition. In place of the electrocoating compositions, can be supplied a direct to metal coating composition or a variety of primer compositions that can repair the damage to a substrate.

Due to the differences in the film forming binders and other additives that are used in each of the repair layers, the tint compositions, which are used to provide each coating composition with a color area, are generally not compatible between individual layers. For this reason, the direct to metal, primer and sealer compositions have generally been provided as already colored compositions that are tinted in one or more color areas, for example, white, black, gray and red, that can provide a desired level of hiding and coloration for the subsequently applied coating compositions. In some instances, the primer, sealer or direct to metal coating compositions may be tintable which can provide the applicator with the ability to use less of the basecoat or topcoat compositions in order to adequately hide the underlying layers while still matching the color of an undamaged portion of the substrate. One such commercial example of a tintable primer composition is available from DuPont, known as VALUESHADE® which allows the primer to be tinted to several shades of gray. However, the tint compositions that are used to provide the color to the primer, sealer or direct to metal compositions are not generally suitable to be used in the basecoat, topcoat or clearcoat compositions. Separate systems of tint compositions are often developed for each.

Another issue with currently available coating compositions is the use of different pigments in each of the layers. There exists the potential for intermixing between dried but uncured coating layers when one layer of a coating composition is applied over another. If one wet layer intermixes with another layer, it can potentially disrupt the color of the cured composite multilayer coating, causing a mottled look.

It would be desirable to provide a refinish coating system that uses one set of tints that can be incorporated into all of the coating compositions. It would also be desirable to provide a system wherein intermixing of one layer with another layer would not cause a mottled look to the cured composite multilayer coating.

### STATEMENT OF THE DISCLOSURE

The present disclosure is directed to a coating system comprising two or more coating compositions wherein the first coating composition is a direct to metal composition, a primer composition, a sealer composition, a basecoat composition, a topcoat composition or a clearcoat composition; and the second coating composition is selected from the same group of coating compositions, but is different from said first coating composition, wherein the first coating composition comprises:
a) a first film forming binder; and
b) a tint composition;
   wherein the second coating composition comprises:
c) a second film forming binder; and
d) said tint composition; and
   wherein the tint composition comprises:
i) at least one pigment;
ii) at least one grind resin; and
iii) at least one solvent; and
   wherein each of the first and second coating compositions are different and use the same tint composition.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including every value between the minimum and maximum values.

As used herein:

The term “topcoat composition” means a coating composition that provides the desired color area for the substrate. The topcoat composition can have a glossy finish or a matte finish and is not intended to be overcoated with a clearcoat composition. The term “basecoat composition”, on the other hand, means a coating composition that provides the desired color area for the substrate and is intended to be overcoated with a clearcoat composition.

The term “tint composition” means a composition comprising or consisting essentially:
i) at least one pigment,
ii) at least one grind resin; and
iii) at least one solvent.

A tint composition is a concentrated pigment mixture that can be added in a relatively small portion to a coating composition to provide a tinted coating composition. In some embodiments, the tint composition comprises more than one pigment to produce a tint composition of a desired color. For example, a green tint composition can comprise both blue pigment and yellow pigment. In other embodiments, two or more different tint compositions can be mixed together to form a new tint composition having a color that is different than the original two or more tint compositions. This new tint composition can then be added to the coating compositions to form tinted coating compositions. In another embodiment, two or more tint compositions can be added to the coating composition and then mixed to provide the tinted coating composition.

The term “coating system” means a collection of the components that can be used to produce the necessary coating compositions that can be used to repair an OEM coating, such as, for example, repairing a damaged portion of an automobile coating. The components can include, for example, coating compositions comprising film forming binders, optional crosslinking agents, solvents and other additives common to refinish coating compositions; and the tint compositions. In some embodiments, the coating compositions, as supplied, are free from or are essentially free from tints or other pigments. In other embodiments, at least a portion of the coating compositions can be supplied with pigments and/or fillers that can provide a neutral color, for example, a white color, to a coating composition. As an example, primer compositions typically have fillers added to them to increase the cured primers ability to be to sanded. Such fillers can add color to the primer composition. When the coating compositions are being prepared for application to a substrate, one or more tint compositions can be added to the coating composition to form a tinted coating composition which is then applied to the substrate. In general, the coating system will include the components necessary to repair the coatings of the substrate in order to match its original, undamaged state. The coating system can also include metallic effect pigments that can provide a metallic sparkle to the repaired substrate. Such metallic effect pigments can be loose flakes or they can be dispersed in a liquid carrier and optionally a resin.

The present disclosure relates to a coating system comprising two or more coating compositions wherein the first coating composition is a direct to metal composition, a primer composition, a sealer composition, a basecoat composition, topcoat composition or a clearcoat composition; and wherein the second coating composition is selected from the same group of coating compositions but is different from said first coating composition. The first coating composition comprises a first film forming binder and a tint composition. The second coating composition comprises a second film forming binder and the same tint that was added to the first coating composition. Obviously, the tint composition that is added to the second coating composition is not the same portion of tint composition that was added to the first coating composition. Once a tint composition is added to a coating composition, it is not possible to remove it from the composition. For example, if both a primer coating composition and a basecoat composition are desired that have a blue color, a refinish technician would calculate the amount of tint composition necessary to produce both the desired blue tinted primer composition and the desired blue tinted basecoat composition. To the primer composition would be added the necessary amount of tint composition to produce the desired blue primer composition. Similarly, the necessary amount of tint composition would be added to the basecoat composition to produce the desired blue basecoat composition. The amount of tint composition that is added to each coating composition can vary.

In further embodiments, the coating system can comprise more than two coating compositions corresponding to one or more of each of the coating compositions necessary to repair a damaged coating on a substrate. For each subsequent coating composition, the tint composition can be added or the composition can be free from the tint composition, with the proviso that at least two of the coating compositions comprise the same tint composition. In some embodiments, the first coating composition can be a tinted primer composition, the second coating composition can be a tinted basecoat composition and the third coating composition can be a clearcoat composition that does not contain the tint. In other embodiments, the first coating composition can be a tinted primer composition, the second coating composition can be a tinted basecoat composition and the third coating composition can be a tinted clearcoat composition.

In some embodiments, the first coating composition is a direct to metal composition and the second coating composition is a primer composition, a sealer composition, a basecoat composition, a topcoat composition or a clearcoat composition. In other embodiments, the first coating composition is a primer composition and the second coating composition is a direct to metal composition, a sealer composition, a basecoat composition, a topcoat composition or a clearcoat composition. In further embodiments, the first coating composition is a sealer composition and the second composition is a direct to metal composition, a primer composition, a basecoat composition, a topcoat composition or a clearcoat composition. In other embodiments, the first coating composition is a basecoat composition and the second coating composition is a direct to metal composition, a primer composition, a sealer composition, a topcoat composition or a clearcoat composition. In other embodiments, the first coating composition is a topcoat composition and the second coating composition is a direct to metal composition, a primer composition, a sealer composition, a basecoat composition or a clearcoat composition. In still further embodiments, the first coating composition is a clearcoat composition and the second coating composition is a direct to metal composition, a primer composition, a sealer composition, a basecoat composition or a topcoat composition.

The coating system can be supplied with a plurality of tint compositions. The tint compositions can be used individually or, in other embodiments, a combination of two or more tint compositions can be mixed to provide a color not provided for by any one of the individual plurality of tint compositions.

It has been found that using the same tint composition in two or more coating compositions, especially wherein the second layer of coating composition is applied directly over at least a portion of an applied layer of the first coating composition can provide a multilayer coating composition with a closer color match to a color standard when compared to using two or more coating compositions that comprise different tints. This closer color matching to a standard color is found even when the second applied coating composition is applied at a thickness that results in the complete hiding of the first applied layer.

In some embodiments, the addition of the same tint composition to each of the two or more coating compositions, results in a dried and cured layers of the coating system having an absolute color difference, ΔE, that is less than 2.0 from a color value of a color standard. In other embodiments, the absolute color difference is less than 1.5 and, in still further embodiments, is less than 1.0. Color measurement and the calculation of color difference, ΔE, is well known by one of ordinary skill in the art. One method of color measurement is to use a colorimeter, for example colorimeters produced by Byk-Gardner from Columbia, Md. In order to calculate ΔE, the color measurement of a color standard is obtained. The color standard can be, for example, the color measurement from an undamaged portion of an automobile. The color measurement data can be loaded into a color matching computer system which can provide, as an output, the most likely tint formulation for matching the color standard. The output color formulation from the color matching computer system can be used to produce the desired tint composition for use in the two or more coating compositions. After the application, drying and curing of the tinted coating compositions to the substrate, a color measurement of the applied layer is obtained. The absolute value of the difference of the color standard and second color measurements is the color difference, ΔE.

The tint composition comprises or consists essentially of:
i) at least one pigment,
ii) at least one grind resin; and
iii) at least one solvent.
   Further examples of pigments can include, those commonly used in the paint industry and/or listed in the Dry Color Manufacturers Association (DCMA), as well as special effect pigments. The pigment can include, for example, a finely divided solid powder that is insoluble but wettable under the conditions of use. The pigment can be organic or inorganic and can be agglomerated or non-agglomerated. Pigments can be incorporated into the coatings by grinding or simple mixing. Pigments can be incorporated by use of a grind resin, such as an acrylic grind resin.

Example pigments and/or pigment compositions can include, for example, carbazoles, dioxazines, azo, monoazo, diazo, salt type (lakes), benzimidazolones metal complexes, isoindolinones, isoindolines and polycyclic phthalocyanines, quinacridones, perylenes, perinones, diketopyrrolo pyrroles, thioindigos, anthraquinones, indanthrones, anthrapyrimidines, flavanthrones, pyranthrones, anthanthrones, triarylcarboniums, quinophthalone pigments, titanium dioxide, carbon black and combinations thereof.

Dyes can also be used. Examples of dyes can include, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, quinacridone, thiazole, thiazine, azo, indigo, nitro, nitroso, oxazine, phthalocyanine, quinoline, stilbene, and triphenyl methanes.

The grind resin is a polymer that is soluble or at least partially soluble in the organic or aqueous solvent that is used in the coating composition and also contains functional groups that are pigment adsorbing groups and are able to form stable, non-flocculating pigment dispersions. Grind resins are generally acrylic polymers that can be linear copolymers, block copolymers, graft copolymers or combinations of these copolymers.

The grind resin can comprise pigment adsorbing groups that can be pendant to the backbone of linear copolymers, pendant to one or more of the blocks of block copolymers or can be pendant to one or both of the backbone or graft arms of graft copolymers. The pigment adsorbing groups can be any of those known in the art of pigment dispersing resins including, for example, aromatic esters, aromatic amines, aliphatic amines, quaternary ammonium groups, acyclic amides, cyclic amides, primary and secondary amides, nitro groups, carboxylic acids or a combination thereof. In some embodiments, it can be useful to include more than one type of pigment adsorbing group per copolymer. In other embodiments, combinations of two or more copolymers can be used each with the same or different pigment adsorbing groups present per copolymer. Suitable examples of grind resins can be found in US 2008/0139738 and U.S. Pat. No. 7,288,589.

The solvent used for the tint composition can be an aqueous or an organic solvent. The selection of solvent depends upon the requirements of the specific end use application, such as the volatile organic content requirements, the selected pigment and the selected grind resin. Representative examples of organic solvents which are useful can include alcohols, such as methanol, ethanol, n-propanol, and isopropanol; ketones, such as acetone, butanone, pentanone, hexanone, and methyl ethyl ketone; alkyl esters of acetic, propionic, and butyric acids, such as ethyl acetate, butyl acetate, and amyl acetate; ethers, such as tetrahydrofuran, diethyl ether, and ethylene glycol and polyethylene glycol monoalkyl and dialkyl ethers such as cellosolves and carbitols; and, glycols such as ethylene glycol and propylene glycol; or a combination thereof.

The coating system comprises two or more coating compositions. The first coating composition can be selected from a direct to metal composition, a primer composition, a sealer composition, a basecoat composition, a topcoat composition or a clearcoat composition. The second coating composition is different from the first coating composition. Each of the coating compositions can be crosslinkable coating compositions or they can be non-crosslinked coating composition. For example, the coating system can comprises a first coating composition that is a crosslinkable primer composition and a second coating composition that is a non-crosslinking basecoat composition.

The coating compositions comprise a film forming binder and the tint composition. Suitable film forming binders can be any of those that are currently in use as coating compositions, such as, for example, acrylic polymer, polyesters, polyurethanes, polyesterurethanes, polyethers, polyesterethers, epoxy resins and a combination thereof. If the coating composition is to be crosslinked, then the film forming binder comprises a crosslinkable component that comprise any of the above mentioned polymers wherein the polymers contain functional groups that are able to react with a crosslinking component to form the crosslinked film.

The coating compositions can also comprise organic or aqueous solvents, crosslinking agents, fillers, rheology control agents, light screeners or light absorbing compounds or a combination thereof.

The present disclosure is also related to a method of applying two or more coating compositions to a substrate wherein the method comprises or consists essentially of the steps of:
1) selecting a tint composition;
2) mixing a portion of said tint composition and a first coating composition to form a first tinted coating composition;
3) applying a layer of the first tinted coating composition to the substrate;
4) mixing a portion of said tint composition and a second coating composition to form a second tinted coating composition;
5) applying a layer of the second tinted coating composition to the substrate;
   wherein the two or more coating compositions are different coating compositions and are selected from a direct to metal composition, a primer composition, a sealer composition, a basecoat composition, a topcoat composition or a clearcoat composition. The method may further comprise the step of flash drying and/or curing the applied layer of first tinted coating composition prior to the application of the layer of the second tinted coating layer to the substrate. In some embodiments, the layer of second tinted coating composition is applied to at least a portion of the applied layer of first tinted coating composition. The disclosure is also related to a method of applying two or more coating compositions wherein at least two of the two or more coating compositions comprise the same tint composition.

The tint composition to be added to each coating composition can be selected via known methods. In some embodiments, a colorimeter can be use to measure the color properties of an undamaged portion of an automobile. The color data can be downloaded to a computer equipped with color matching software. The color match software can analyze the color data and provide the tint composition or compositions, including the amount of each tint composition that are to be added to the coating compositions to match the color of the undamaged coating. In other embodiments, a color library can be used to provide a close match to a desired color. The color library provides the tint compositions and amounts that are necessary to provide tinted coating compositions having the desired color. In still further embodiments, custom colors can be created those of ordinary skill in the art to produce the desired tinted coating compositions.

### EXAMPLES

Unless otherwise specified, all ingredients are available from DuPont, Wilmington, Del. under the IMRON® paint system.

A panel coated with IMRON® 42P “Bright Red” paint was analyzed using an X-RITE® MA 24 spectrophotometer. This data was used as the red color standard. The color data provided by the spectrophotometer was loaded into a MÖBIUS® color match system and the formulation output was used to create tint composition 1 and a comparative red topcoat.

A panel coated with IMRON® 42P “Bright Yellow” paint was analyzed using an X-RITE® MA 24 spectrophotometer. This data was used as the yellow color standard. The color data provided by the spectrophotometer was loaded into a MOBIUS® color match system and the formulation output was used to create tint composition 2 and a comparative yellow topcoat.

A panel coated with IMRON® 42P “Alert Orange” paint was analyzed using an X-RITE® MA 24 spectrophotometer. This data was used as the orange color standard. The color data provided by the spectrophotometer was loaded into a MOBIUS® color match system and the formulation output was used to create tint composition 3 and a comparative orange topcoat.

Preparation of Tint Compositions

TABLE 1

| | Tint | | Tint | | Tint | |
|---|---|---|---|---|---|---|
| Tint | Composition 1 | | Composition 2 | | Composition 3 | |
| 713P Blue | | | 8.0 | grams | | |
| 714P Yellow | | | 15,516.0 | grams | | |
| 717P White | 311.0 | grams | 2360.0 | grams | 1453.0 | grams |
| 718P Black | | | | | 17.0 | grams |
| 721P Orange | | | | | 5469.0 | grams |
| 724P Yellow | | | | | 8996.0 | grams |
| 726P Red | 2466.0 | grams | | | | |
| 727P Violet | | | 20.0 | grams | | |
| 730P Red | 6056.0 | grams | | | | |

The tints of Table 1 were added to suitable mixing vessels and stirred until homogeneous mixtures formed. The tint compositions were used as is.

Preparation of Primer and Topcoat Compositions

TABLE 2

| | | Red | Yellow | Yellow | Orange | Orange |
|---|---|---|---|---|---|---|
| | Red Primer | Topcoat | Primer | Topcoat | Primer | Topcoat |
| Tint Composition 1 | 883.3 grams | 1698.1 grams | | | | |
| Tint Composition 2 | | | 1790.0 grams | 1444.5 grams | | |
| Tint Composition 3 | | | | | 1740.9 grams | 1593.5 grams |
| 790P binder | 1348.5 grams | | 491.0 grams | | 741 grams | |
| 791P binder | 908.3 grams | | 1878.0 grams | | 1527.8 grams | |
| 740P binder | | 1110.2 grams | | 382.7 grams | | 862.8 grams |
| 741P binder | | 1155.4 grams | | 1514.8 grams | | 750.5 grams |

The ingredients for each primer and topcoat of Table 2 were added to a suitable mixing vessels and stirred until a homogeneous mixture formed. Prior to use, the primer compositions were activated with FG-633® activator. 8 parts by volume of the primer composition was mixed with 1 part by volume of the activator. The activated primer compositions were drawn down on glass plates to yield a dry film thickness of about 127 micrometers and allowed to cure for 24 hours at ambient temperature.

The topcoat compositions were activated with VHY-691® activator. 4 parts by volume of the topcoat compositions were mixed with 1 part by volume of the activator. A layer of the activated red topcoat was then applied to the cured red primer to yield a dry film thickness of about 50.8 micrometers and allowed to cure for 24 hours at ambient temperature. A layer of the activated yellow topcoat was then applied to the cured yellow primer to yield a dry film thickness of 50.8 micrometers and allowed to cure for 24 hours at ambient temperature. A layer of the activated orange topcoat was then applied to the cured orange primer to yield a dry film thickness of 50.8 micrometers and allowed to cure for 24 hours at ambient temperature.

Preparation of Comparative Primer and Topcoats

TABLE 3

| | | | | Comparative | | Comparative |
|---|---|---|---|---|---|---|
| | Comparative | Comparative | Comparative | Yellow | Comparative | Orange |
| | Primer 1 | Red Topcoat | Primer 2 | Topcoat | Primer 3 | Topcoat |
| 713P blue | | | | 0.8 grams | | |
| 714P yellow | | | | 1551.6 grams | | |
| 717P white | 883.3 grams | 31.1 grams | 1790.0 grams | 236.0 grams | 1760.0 grams | 147.0 grams |
| 718P black | | | | | | 1.7 grams |
| 721P Orange | | | | | | 546.9 grams |
| 724P Yellow | | | | | | 899.6 grams |
| 726P red | | 246.4 grams | | | | |
| 727P violet | | | | 2.0 grams | | |
| 730P red | | 605.4 grams | | | | |
| 790P binder | 1348.5 grams | | 491.0 grams | | 741.0 grams | |
| 791P binder | 908.3 grams | | 1878.0 grams | | 1527.8 grams | |
| 740P binder | | 1110.2 grams | | 382.7 grams | | 862.8 grams |
| 741P binder | | 1155.4 grams | | 1514.8 grams | | 750.5 grams |

The ingredients for each of the coating compositions were added to a suitable mixing vessels and stirred until a homogeneous mixture formed. Each primer composition was activated using FG633® activator. 8 parts by volume of the primer composition were mixed with 1 parts by volume of the activator to give an activated primer composition. The activated primer compositions were drawn down on glass plates to yield a dry film thickness of about 127 micrometers and allowed to cure for 24 hours at ambient temperature.

Each of the comparative topcoats were activated with VHY-691® activator. 4 parts by volume of the topcoat compositions were mixed with 1 part by volume of the activator. A layer of the comparative red topcoat was applied to the cured comparative primer composition 1 to yield a dry film thickness of about 50.8 micrometers. The applied comparative red topcoat was allowed to dry and cure at ambient temperature for 24 hours. A layer of the comparative yellow topcoat was applied to the cured comparative primer composition 2 to yield a dry film thickness of about 50.8 micrometers. The applied comparative yellow topcoat was allowed to dry and cure at ambient temperature for 24 hours. A layer of the comparative orange topcoat was applied to the cured comparative primer composition 3 to yield a dry film thickness of about 50.8 micrometers. The applied comparative orange topcoat was allowed to dry and cure at ambient temperature for 24 hours.

Each of the red topcoat, yellow topcoat, orange topcoat, comparative red topcoat, comparative yellow topcoat and comparative orange topcoat was analyzed using an X-RITE® MA 24 spectrophotometer and the differences in color versus their respective red, yellow or orange color standard was determined.

TABLE 4

| | | | | Comparative | | |
|---|---|---|---|---|---|---|
| | Red | Comparative | Yellow | Yellow | Orange | Comparative |
| | Topcoat | Red Topcoat | Topcoat | Topcoat | Topcoat | Orange Topcoat |
| ΔE | 0.8 | 2.5 | 0.7 | 3.8 | 0.8 | 2.5 |

The results indicate that using the same tint compositions for two coating compositions provides a final color product that more closely matches a target color.

What is claimed is:

1. A coating system comprising two or more coating compositions wherein the first coating composition is a direct to metal composition, a primer composition, a sealer composition, a basecoat composition, a topcoat composition or a clearcoat composition; and the second coating composition is selected from the same group of coating compositions, but is different from said first coating composition, wherein the first coating composition comprises:
a) a first film forming binder; and
b) a tint composition;
wherein the second coating composition comprises:
c) a second film forming binder; and
d) said tint composition; and
wherein the tint composition comprises:
i) at least one pigment,
ii) at least one grind resin; and
iii) at least one solvent; and
wherein each of the first and second coating compositions are different and use the same tint composition.

2. The coating system of claim 1 further comprising one or more subsequent coating compositions wherein each subsequent coating composition comprises:
e) a subsequent film forming binder; and
f) optionally, the tint composition;
wherein each subsequent coating composition is different from any of the previous coating compositions.

3. The coating system of claim 1 wherein dried and cured layers of the coating system have an absolute value color difference, ΔE, of less than 2.0 from a color value of a color standard.

4. The coating system of claim 1 wherein the grind resin comprises a polymer having pigment adsorbing groups wherein the pigment adsorbing groups are selected from aromatic esters, aromatic amines, aliphatic amines, quaternary ammonium groups, acyclic amides, cyclic amides, primary and secondary amides, nitro groups, carboxylic acids or a combination thereof.

5. The coating system of claim 1 wherein the first and second coating compositions further comprise two or more of said tint compositions, wherein the first tint composition comprises a first color and the second tint composition comprises a second color different from the first color.

6. The coating system of claim 5 wherein the first and second coating compositions comprise a plurality of tint compositions, each tint composition providing a different color from the other tint compositions.

7. The coating system of claim 6 wherein two or more of the plurality of tint compositions can be mixed to form a tint composition that produces a color not provided for by any one of the individual plurality of tint compositions.

8. A method of applying two or more coating compositions to a substrate, said method comprising the steps of;
1) selecting a tint composition;
2) mixing a portion of said tint composition and a first coating composition to form a first tinted coating composition;
3) applying a layer of the first tinted coating composition to the substrate;
4) mixing a portion of said tint composition and a second coating composition to form a second tinted coating composition;
5) applying a layer of the second tinted coating composition to the substrate;
wherein the two or more coating compositions are different coating compositions and are selected from a direct to metal composition, a primer composition, a sealer composition, a basecoat composition, a topcoat composition or a clearcoat composition.

9. The method of claim 8 wherein the tint composition comprises:
i) at least one pigment;
ii) at least one grind resin; and
iii) at least one solvent.

10. The method of claim 8 wherein the layer of second tinted coating composition is applied to at least a portion of the applied layer of the first coating composition.

11. The method of claim 1 wherein the applied layer of first tinted coating composition is flash dried and cured prior to the application of the second tinted coating composition.
